(19) United States
(12) Patent Application Publication
(10) Pub. No.: US 2016/0180056 A1
(43) Pub. Date: Jun. 23, 2016

(54) PROCESSING A SEARCH RESULT FROM A MEDICAL QUERY-BASED SEARCH

(71) Applicant: KONINKLIJKE PHILIPS N.V., Eindhoven (NL)

(72) Inventor: IWO WILLEM OSCAR SERLIE, BEST (NL)

(73) Assignee: Koninklijke Philips N.V., Eindhoven (NL)

(21) Appl. No.: 14/909,484

(22) PCT Filed: Aug. 12, 2014
(86) PCT No.: PCT/EP2014/067190

§ 371 Date: Feb. 2, 2016

(30) Foreign Application Priority Data
Aug. 13, 2013 (EP) 13180196.1

(51) Int. Cl. G06F 19/00

(52) U.S. Cl. CPC G06F 19/3443

(57) ABSTRACT

A system (100) is provided for processing a search result of a medical query (122) which is submitted to a search engine (040), e.g., by a user. The system (100) comprises an interface (120) for receiving search data (042) constituting a response of the search engine to the query (122), the search data identifying a first document in a medical document repository (080). The system (100) further comprises an analysis subsystem (140) for analyzing the first document to determine a time period (410) based on the first document comprising information which is indicative of the time period and by matching the information from the first document to medical information items from a medical database, and identifying a second document in the medical document repository based on a time or date associated with the second document falling within the time period. The system (100) enables the second document to be identified, e.g., to the user, together with the first document as identified by the search result. As such, the user can be provided with documents from a medical document repository which otherwise may have not been identified by the query-based search.

### FIELD OF THE INVENTION

The invention relates to a system and method for processing a search result of a medical query which is submitted to a search engine. The invention further relates to a workstation comprising the system, and to a computer program product comprising instructions for causing a processor system to perform the method.

### BACKGROUND OF THE INVENTION

Search engines are well known for enabling users to search databases or other forms of repositories for information. In particular, it is known to use a search engine to search for documents in a document repository. For that purpose, a user may provide a query to the search engine, e.g., by entering the query via a user interface. The search engine may then search the documents in the document repository based on the query. For example, if the query is a keyword, the search engine may search the documents for one or more occurrences of the keyword. As a result, the search engine may generate search data which identifies one or more documents which were found during the search. Such search data may be displayed to the user so as to enable the user to see which documents were found. Additionally, the contents of the found documents may be displayed, or be made accessible to the user.

For example, in the medical domain, a radiologist may, as part of a radiology workflow, seek to answer a clinical question which is asked by a referring physician via a radiology request. To answer the clinical question, the radiologist typically wishes to collect all relevant information for the particular case. This may involve entering a query into a search engine which may be part of a Hospital Information System (HIS) to search for documents which contain relevant information to the particular case. As a result, the radiologist may be presented with search results identifying documents such as a report of a previous study which includes an overview of previous findings and recommendations, prior clinical letters, or pathology reports which are relevant to the current clinical question, etc.

Disadvantageously, the query provided by the user may fail to identify relevant documents which exist in the document repository. A reason for this may be that, e.g., the query is imprecisely or too narrowly defined by the user. Accordingly, the user may not learn about said relevant documents which exist in the document repository.

WO 2012/042447 describes a system for generating a refined medical query from a user medical query, the user medical query comprising a user medical term, and the system comprising an input for receiving the user medical query from a user, an access controller for accessing a medical guideline file and a rules repository, the medical guideline file comprising a medical information item, and the rules repository comprising a rule linking the medical information item to the user medical term, and a query refiner for generating the refined medical query from the user medical query by including the medical information item in the refined medical query and for providing the refined medical query to a search engine.

### SUMMARY OF THE INVENTION

Although the system of WO 2012/042447 improves the relevance of search results, it would be advantageous to further improve on the relevance of search results which are provided in response to a medical query submitted to a search engine.

To better address this concern, a first aspect of the invention provides a system for processing a search result of a medical query which is submitted to a search engine, the system comprising:

an interface for receiving search data constituting a response of the search engine to the medical query, the search data identifying a first document in a medical document repository;

an analysis subsystem for:

i) retrieving the first document from the medical document repository;
ii) accessing a medical database comprising a plurality of medical information items, each of the plurality of medical information items being associated with a medical time period;
iii) analyzing the content of the first document to determine a time period based on the first document comprising information which is indicative of the time period and by matching the information from the first document to one of the plurality of medical information items, thereby identifying the medical time period associated with said medical information item as the time period;
iv) identifying a second document in the medical document repository based on a time or date associated with the second document falling within the time period;
v) generating supplementary data identifying the second document in the medical document repository for enabling identifying the second document together with the response of the search engine to the medical query.

In a further aspect of the invention, a workstation and imaging apparatus is provided comprising the system set forth.

In a further aspect of the invention, a method is provided for processing a search result of a medical query which is submitted to a search engine, the method comprising:

receiving search data constituting a response of the search engine to the medical query, the search data identifying a first document in a medical document repository;

retrieving the first document from the medical document repository;

accessing a medical database comprising a plurality of medical information items, each of the plurality of medical information items being associated with a medical time period;

analyzing the content of the first document to determine a time period based on the first document comprising information which is indicative of the time period and by matching the information from the first document to one of the plurality of medical information items, thereby identifying the medical time period associated with said medical information item as the time period;

identifying a second document in the medical document repository based on a time or date associated with the second document falling within the time period; and

generating supplementary data identifying the second document in the medical document repository for enabling identifying the second document together with the response of the search engine to the medical query.

In a further aspect of the invention, a computer program product is provided comprising instructions for causing a processor system to perform the method set forth.

The measures according to the invention provide a system with an interface to a search engine to enable the system to receive search data from the search engine. The interface may be, e.g., a network interface. The search data as received via the interface constitutes a response of the search engine to a medical query, e.g., as submitted by a user. As such, the search data identifies at least one medical document, i.e., a first document, which has been found by the search engine during the query-based search. The first document has been found in a medical document repository, such as a medical database or a plurality of medical databases which are accessible to the search engine when performing the query-based search. The search data identifies the first document in that it enables the first document to be located in the medical document repository. The search data may, but typically does not, comprise the first document itself.

A medical database is accessed which comprises medical information items such as non-patient specific medical terms or concepts, clinical questions, decision options and their outcomes, etc., as well as medical time periods which are associated with said medical information items. Here, the term medical time period refers to a time period which has a medically relevant meaning in the context of the medical information item. For example, several medical information items may relate to possible symptoms of testicular cancer, while indicating as medical time period a period for treatment for testicular cancer, namely several weeks.

An analysis subsystem is provided which retrieves the first document as identified by the search data from the medical document repository. Having retrieved the first document, the analysis subsystem analyzes the first document, e.g., by analyzing its content. The analysis subsystem analyzes the first document to identify a medical information item in the first document which is also comprised in the medical database and which has a medical time period associated therewith. For example, the analysis subsystem may determine that the first document describes one of the possible symptoms of testicular cancer.

Accordingly, the analysis subsystem may determine the period for treatment as the time period, and subsequently identify a second document based on its associated time or date falling within said period for treatment. For example, if the first document is a report of a first exam of a patient, the analysis subsystem may identify as the second document a report of a follow-up exam of the same patient. Another example is that a phrase such as “A treatment regime is proposed for the coming three months” may be directly indicative of a time period, in that, together with a date of creation being included in the first document, the analysis subsystem may determine that the time period runs from the date of the creation of the first document until approximately three months later.

Having determined the time period from the content of the first document, the analysis subsystem uses the time period to identify at least one further document in the medical document repository. The further, i.e., second, document is identified based on a time or date being associated with the second document falling within the time period, e.g., after the beginning of the time period and before the end of the time period. The time or date may be provided in the form of a timestamp or other types of metadata which indicates a time and/or a date and which is recorded in association with the second document. For example, the time or date may be a date of creation or date of last modification of the second document, as maintained by the medical document repository in the form of metadata. Another example is a time or date which has been included in the second document itself, i.e., as part of its content.

Having found the second document, the analysis subsystem generates supplementary data which identifies the second document in the medical document repository. For example, the supplementary data may comprise a name of the document and address information which enables the second document to be located in the medical document repository. In particular, the supplementary data may be similar or same in format as the search data, e.g., identify similar properties of the documents, have a similar data structure, etc. Accordingly, the supplementary data can be used together with the search data to simultaneously identify the originally found first document and the later found second document, e.g., to the user.

The inventors have recognized that medical documents which are found by a search engine in response to a medical query typically identify one or more relevant documents. However, a search engine frequently fails to identify other relevant documents in a query-based search. A reason for this is that the medical query may be imprecise, too narrow, etc. Moreover, even refining or broadening the medical query based on semantically related query terms may fail to identify such other relevant documents. This may occur if, for example, the documents relate to an episode of care of a patient but each concerns a different aspect of said episode of care. Here, an “episode of care” is understood to consist of all clinically related services for one patient for a discrete diagnostic condition from the onset of symptoms until treatment is complete.

The invention is based in part on the recognition that such other relevant documents may be identified based on the assumption that these documents have a relation in time with the document originally found by the search engine. By analyzing the originally found document, i.e., the first document, for such a time period, the system is enabled to identify at least one other relevant document, namely by identifying the second document based on a time or date which is associated with the second document falling within the time period. By generating supplementary data identifying the second document in the document repository, the second document can be identified to the user together with the response of the search engine.

Identifying additional documents, i.e. second documents, associated with the same time period is particularly advantageous in the present medical context, where such documents are likely to relate to the same episode of care of a patient. Thus, the additional documents identified by the analysis subsystem will have a relatively high degree of relevance for the medical query submitted by the user, while such documents could not have been found by the initial query-based search using conventional search techniques. Advantageously, the user is automatically provided with other relevant documents which otherwise may have not been identified by the query-based search. It is therefore not needed for the user to manually refine the medical query to enable the search engine to identify said relevant documents. Advantageously, it is less likely that a user such as a radiologist misses a relevant document when collecting information for a particular case.

Optionally, the plurality of medical information items comprises at least one of: a pathology and an anatomy. A medical document such as the first document may frequently refer to pathologies and/or anatomies, such as anatomical parts or structures. By the analysis subsystem accessing a medical database which comprises such medical information items, the system is able to determine the associated medical time periods.

Optionally, the analysis subsystem is arranged for identifying the second document in the medical document repository by generating a second query for the search engine which specifies the time period. The analysis subsystem thus involves the search engine in identifying the second document, e.g., by generating the second query to search for documents which have an associated time or date within the time period. Advantageously, it is not needed for the analysis subsystem itself to be able to search the medical document repository.

Optionally, the search data identifies a plurality of documents in the medical document repository, the search data is indicative of a ranking of the plurality of documents, and the analysis subsystem is arranged for selecting the first document from the plurality of documents based the ranking. The search data is thus indicative of which documents were deemed to be most relevant by the search engine in view of the query. By selecting the first document amongst the plurality of documents based on the ranking, the analysis subsystem is enabled to select a most relevant one of the plurality of documents as the first document. Advantageously, since the second document is identified based on a most relevant first document, the system is enabled to identify a more relevant second document as well.

Optionally, the analysis subsystem is arranged for identifying further documents in the medical document repository by iteratively updating the time period based on an analysis of a previously identified document. A previously identified document, such as the second document, is thus analyzed by analysis subsystem, e.g., by retrieving the previously identified document from the medical document repository, analyzing the previously identified document to determine a second time period based on the second document comprising information which is indicative of the second time period, and updating the originally determined time period based on the second time period. The analysis subsystem is therefore enabled to iteratively better define the time period, namely by updating the time period to identify further documents and subsequently analyzing the further documents to update the time period. Advantageously, the system is enabled to identify more relevant documents.

Optionally, the system further comprises a user interaction subsystem arranged for:

enabling a user to input the medical query for submission to the search engine via the system; and

visually indicating the first document and the second document to the user in response to the query.

The system thus functions as an intermediary between the user and the search engine in that the user is enabled to input the query for the search engine via the system and in that the system visually indicates the search results to the user, namely the first document as originally identified by the search engine and the later identified second document.

Optionally, the user interaction subsystem is arranged for indicating the time period to the user. The user is thus enabled to learn how the second document was identified. Advantageously, if the user considers the indicated time period to be erroneous, the user can ignore the second document, e.g., by omitting consulting its contents.

Optionally, the user interaction subsystem is arranged for enabling the user to modify the time period, and the analysis subsystem is arranged for identifying the second document and/or a further document based on said modified time period. The user is thus enabled to modify the time period as determined by the analysis subsystem, either before the second document is identified based on the time period, or thereafter, i.e., before identifying a further document. Advantageously, the user obtains more control over the identification.

Optionally, the user interaction subsystem is arranged for enabling the user to input a time limit, and the analysis subsystem is arranged for determine the time period based on the time period falling within the time limit. By enabling the user to input a time limit, the user is enabled to specify reasonable limits to the time period as determined by the system, e.g., based on the user's expectancy regarding the search results. Advantageously, it can be avoided that the system inadvertently determines a highly erroneous time period.

Optionally, the system further comprises a reporting subsystem arranged for:

generating a report based on a content of the first document; and

supplementing the report based on a content of the second document.

Optionally, the interface is arranged for receiving query data representing the query, and the analysis subsystem is arranged for determining the time period further based on the medical query being indicative of the time period. In addition to the first document, the medical query itself may be indicative of the time period. The analysis subsystem thus uses two separate sources in determining the time period, i.e., the first document and the medical query. Advantageously, the analysis subsystem can more accurately determine the time period.

In summary, the present invention may provide a system for processing a search result of a medical query which is submitted to a search engine, e.g., by a user. The system may comprise an interface for receiving search data constituting a response of the search engine to the query, the search data identifying a first document in a medical document repository. The system may further comprise an analysis subsystem for analyzing the first document to determine a time period based on the first document comprising information which is indicative of the time period and by matching the information from the first document to medical information items from a medical database, and identifying a second document in the document repository based on a time or date associated with the second document falling within the time period. The system enables the second document to be identified, e.g., to the user, together with the first document as identified by the search result. As such, the user can be provided with documents from a medical document repository which otherwise may have not been identified by the query-based search.

Examples of systems and methods for processing a search result of a query which is submitted to a search engine are set out in the following clauses:

1. A system for processing a search result of a query which is submitted to a search engine, the system comprising:

an interface for receiving search data constituting a response of the search engine to the query, the search data identifying a first document in a document repository;

an analysis subsystem for:

i) retrieving the first document from the document repository;

ii) analyzing the first document to determine a time period based on the first document comprising information which is indicative of the time period; and

iii) identifying a second document in the document repository based on a time or date associated with the second document falling within the time period; and

iv) generating supplementary data identifying the second document in the document repository for enabling identifying the second document together with the response of the search engine to the query.

2. The system according to clause 1, wherein the query is a medical query, the first document and the second document are medical documents in a medical document repository, and wherein the analysis subsystem is further arranged for:

accessing a medical database comprising a plurality of medical information items, each of the plurality of medical information items being associated with a medical time period; and

matching the information from the first document to one of the plurality of medical information items, thereby identifying the medical time period associated with said medical information item as the time period.

3. The system according to clause 2, wherein the plurality of medical information items comprises at least one of: a pathology and an anatomy.
4. The system according to clause 1, wherein the analysis subsystem is arranged for identifying the second document in the document repository by generating a second query for the search engine which specifies the time period.
5. The system according to clause 1, wherein the search data identifies a plurality of documents in the document repository, wherein the search data is indicative of a ranking of the plurality of documents, and wherein the analysis subsystem is arranged for selecting the first document from the plurality of documents based the ranking
6. The system according to clause 1, wherein the analysis subsystem is arranged for identifying further documents in the document repository by iteratively updating the time period based on an analysis of a previously identified document.
7. The system according to clause 1, further comprising a user interaction subsystem arranged for:

enabling a user to input the query for submission to the search engine via the system; and

visually indicating the first document and the second document to the user in response to the query.

8. The system according to clause 7, wherein the user interaction subsystem is arranged for indicating the time period to the user.
9. The system according to clause 8, wherein the user interaction subsystem is arranged for enabling the user to modify the time period, and wherein the analysis subsystem is arranged for identifying the second document or a further document based on said modified time period.
10. The system according to clause 7, wherein the user interaction subsystem is arranged for enabling the user to input a time limit, and wherein the analysis subsystem is arranged for determine the time period based on the time period falling within the time limit.
11. The system according to clause 7, wherein the analysis subsystem is arranged for determining the time period further based on the query being indicative of the time period.
12. The system according to clause 1, further comprising a reporting subsystem arranged for:

generating a report based on a content of the first document; and

supplementing the report based on a content of the second document.

13. A workstation or imaging apparatus comprising the system of clause 1.
14. A method for processing a search result of a query which is submitted to a search engine, the method comprising:

receiving search data constituting a response of the search engine to the query, the search data identifying a first document in a document repository;

retrieving the first document from the document repository;

analyzing the first document to determine a time period based on the first document comprising information which is indicative of the time period;

identifying a second document in the document repository based on a time or date associated with the second document falling within the time period; and

generating supplementary data identifying the second document in the document repository for enabling identifying the second document together with the response of the search engine to the query.

15. A computer program product comprising instructions for causing a processor system to perform the method of clause 14. It will be appreciated by those skilled in the art that two or more of the above-mentioned embodiments, implementations, and/or aspects of the invention may be combined in any way deemed useful.

Modifications and variations of the imaging apparatus, the workstation, the method, and/or the computer program product, which correspond to the described modifications and variations of the system, can be carried out by a person skilled in the art on the basis of the present description.

The invention is defined in the independent claims. Advantageous embodiments are defined in the dependent claims.

### BRIEF DESCRIPTION OF THE DRAWINGS

These and other aspects of the invention are apparent from and will be elucidated with reference to the embodiments described hereinafter. In the drawings,

FIG. 1 shows a system for processing a search result of a query which is submitted by a user to a search engine;

FIG. 2 shows a method for processing the search result of the query;

FIG. 3 shows a computer program product comprising instructions for causing a processor system to perform the method;

FIG. 4 illustrates the system using the search result to retrieve and analyze a first document in a document repository so as to determine a time period for use in identifying a second document in the document repository;

FIG. 5 illustrates the system identifying the second document in the document repository based on a time or date of the second document falling within the time period, and the time period being updated based on an analysis of the second document;

FIG. 6 illustrates the system identifying the second document in the document repository further based on a medical discipline associated with the second document; and

FIG. 7 illustrates the user interactively modifying the time period.

It should be noted that items which have the same reference numbers in different Figures, have the same structural features and the same functions, or are the same signals. Where the function and/or structure of such an item has been explained, there is no necessity for repeated explanation thereof in the detailed description.

### DETAILED DESCRIPTION OF EMBODIMENTS

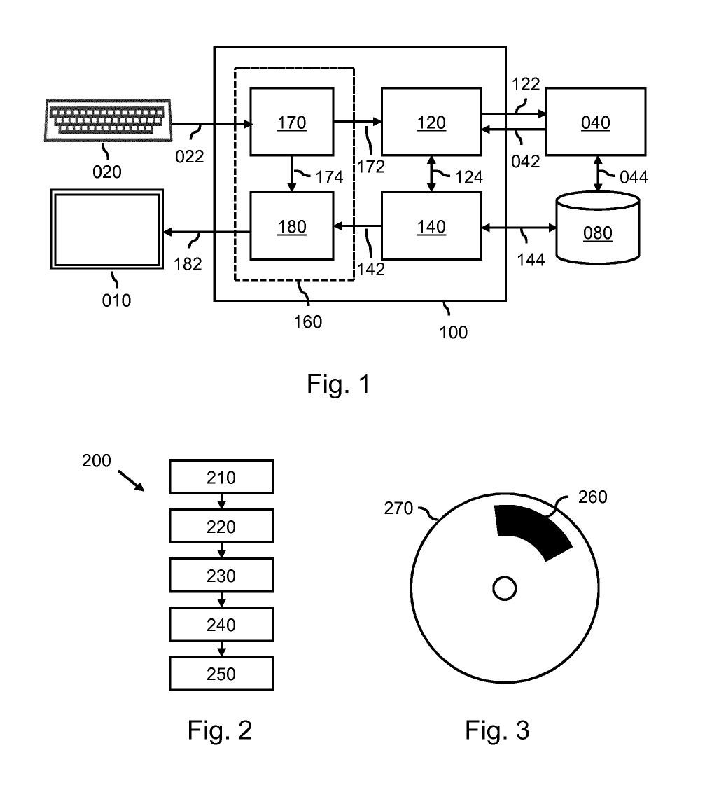

FIG. 1 shows a system 100 for processing a search result of a query 122 which is submitted a search engine 040. The query 122 may be submitted by a user to the search engine 040 in that the user may have generated the query 122 or may have provided input to generate the query 122. Alternatively, the query 122 may be a computer-generated query.

The system 100 comprises an interface 120 for receiving search data 042 constituting a response of the search engine 040 to the query 122. The search data 042 may be received direct from the search engine 040. Alternatively, the search data 042 may be received indirectly from the search engine 040, e.g., via one or more intermediary (sub)systems. The search data 042 identifies at least a first document in a document repository 080. FIG. 1 shows the document repository 080 in the form of a database which is accessible to the search engine 040 in that the search engine 040 can search the database 080, e.g., via an exchange of messages 044. Alternatively, the document repository 080 may be constituted by a plurality of databases which are accessible to the search engine 040. For example, in the medical domain, the plurality of databases may comprise patient record databases, examination report databases, or other databases of a Hospital Information System (HIS). The search data 042 may identify the first document in various ways, e.g., by specifying a file location of the first document in the document repository 080.

The system 100 further comprises an analysis subsystem 140 which is arranged for retrieving the first document, as identified by the search data 042, from the document repository 080. To obtain the search data 042 and/or data identifying the first document from the interface 120, the analysis subsystem 140 is shown to communicate with the interface 120 via an internal exchange of messages 124. FIG. 1 further shows the analysis subsystem 140 directly communicating with the document repository 080 via an external exchange of messages 144 to retrieve the first document from the document repository 080. Alternatively, the analysis subsystem 140 may retrieve the first document via the interface 120, the search engine 040 itself and/or another interface which is not shown in FIG. 1.

The analysis subsystem 140 is arranged for analyzing the first document to determine a time period based on the first document comprising information which is indicative of the time period. Furthermore, the analysis subsystem 140 is arranged for identifying a second document in the document repository based on a time or date associated with the second document falling within the time period. For that purpose, the analysis subsystem 140 may directly communicate with the document repository 080, e.g., via the external exchange of messages 144. Alternatively, the analysis subsystem 140 may identify the second document by involving the search engine 040, e.g., by generating a further query for the search engine 040 which specifies the time period. The analysis subsystem 140 is further arranged for generating supplementary data 142 identifying the second document in the document repository. The supplementary data 142 may identify the first document in various ways, e.g., by specifying a file location of the second document in the document repository 080. Accordingly, the supplementary data 142 enables identifying the second document to the user together with the response of the search engine 040 to the query, i.e., together with the first document and possibly further identified documents.

An operation of the system 100 may be briefly explained as follows. The system 100 receives the search data 042 via the interface 120. Having received the search data 042, the analysis subsystem 140 retrieves the first document from the document repository 080 and then analyzes the first document to determine the time period. The analysis subsystem 140 then uses the time period to identify the second document in the document repository 080. Finally, the analysis subsystem 140 generates the supplementary data 142 to identify the second document in the document repository 080.

FIG. 1 further shows an optional aspect of the present invention in that the system 100 may comprise a user interaction subsystem 160 arranged for enabling the user to input the query 122 for submission to the search engine 040 via the system. Additionally, the user interaction subsystem 160 may be arranged for visually indicating the first document and the second document to the user in response to the query 122 or in response to the search result of the query. FIG. 1 shows the user interaction subsystem 160 being comprised of a user input 170 and a display processor 180. However, this is not a limitation in that the navigation subsystem 160 may also take any other suitable form. The user input 170 may be arranged for receiving user input data 022 from a user input device 020 such as a keyboard, mouse or touch sensitive surface. Accordingly, the user may input the query 122 by appropriately operating the user input device 020. In response, the user input 120 may submit the query 122 to the search engine 040 via the interface 120 and an internal exchange of messages 172 with the interface 120. Moreover, the display processor 180 may be arranged for receiving the supplementary data 142 from the analysis subsystem 140. Although not shown in FIG. 1, the display processor 180 may also be arranged for receiving the search data 042 from the interface. Accordingly, the display processor 180 may be enabled to visually identify the second document to the user together with the first document, e.g., by showing a name, location, date of creation, etc., of both the first document and the second document. For that purpose, the display processor 180 may output display data 182 to a display 010.

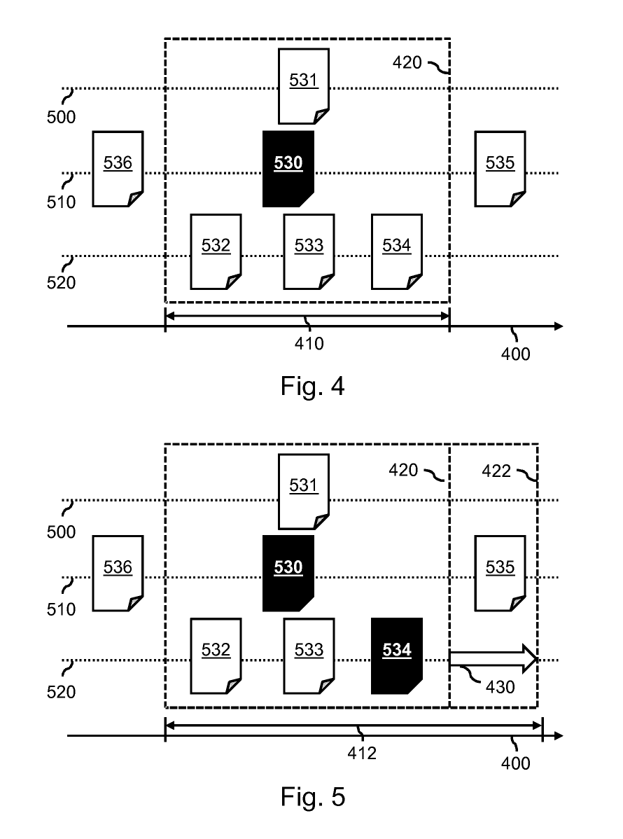

It is noted that the operation of the system 100, including the user interface subsystem 160, will be further explained with reference to FIGS. 4-7.

FIG. 2 shows a method for processing a search result of a query which is submitted to a search engine. The method 200 may correspond to an operation of the system of FIG. 1. However, this is not a limitation, in that the method 200 may also be performed in separation of the system, e.g., using a different system or device.

The method 200 comprises, in a first step titled “RECEIVING SEARCH RESULT”, receiving 210 search data constituting a response of the search engine to the query, the search data identifying a first document in a document repository. The method 200 further comprises, in a second step titled “RETRIEVING FIRST DOCUMENT”, retrieving 220 the first document from the document repository. The method 200 further comprises, in a third step titled “ANALYZING FIRST DOCUMENT TO DETERMINE TIME PERIOD”, analyzing 230 the first document to determine a time period based on the first document comprising information which is indicative of the time period. The method 200 further comprises, in a fourth step titled “IDENTIFYING SECOND DOCUMENT WITHIN TIME PERIOD”, identifying 240 a second document in the document repository based on a time or date associated with the second document falling within the time period. The method 200 further comprises, in a fifth step titled “GENERATING SUPPLEMENTARY DATA IDENTIFYING SECOND DOCUMENT”, generating 250 supplementary data identifying the second document in the document repository for enabling identifying the second document together with the response of the search engine to the query.

FIG. 3 shows a computer program product 260 comprising instructions for causing a processor system to perform the aforementioned method of FIG. 2. The computer program product 260 may be comprised on a computer readable medium 270, for example in the form of a series of machine readable physical marks and/or as a series of elements having different electrical, e.g., magnetic, or optical properties or values.

The system 100 and its operation may be further explained with reference to FIGS. 4-7 and with continued reference to FIG. 1. In the following, the system 100 is described as being adapted for use in the medical domain. However, this is not a limitation, as the system 100 may equally be used in other application domains, either without adaptation or with adaptations analogous to the following. Accordingly, in the medical domain, the query 122 may be a medical query, such as one formulated by a radiologist when seeking to answer a clinical question which is asked by a referring physician via a radiology request. In particular, the query 122 may be formulated by the radiologist to identify all relevant information for the particular case. The radiologist may provide the query 122 to a search engine 040 which may be provided as part of a Hospital Information System (HIS) to enable the radiologist to search for documents which contain said relevant information. The search engine 040 may search various databases within the HIS such as patient record databases, examination report databases, library databases, etc. In particular, the search engine 040 may search patient-specific documents such as patient records and examination reports, and/or patient non-specific documents such as medical guidelines and medical handbooks.

The analysis subsystem 140 may be further arranged for accessing a medical database which aids in the analysis of the first document, namely one which comprises a plurality of medical information items, each of the plurality of medical information items being associated with a medical time period. In particular, the medical database may comprise patient non-specific documents such as medical guidelines and medical handbooks. The medical database may or may not be one which is also searched by the search engine 040. By way of example, in FIG. 1, the medical database is constituted by the document repository 080. The plurality of medical information items may describe different pathological and/or anatomical conditions, signs and/or symptoms, while indicating therewith associated different time periods. An example is a medical handbook describing symptoms of testicle tumor in association with a time frame of two weeks for treatment, while describing symptoms of kidney tumor in association with a time frame of one month. The analysis subsystem 140 may be arranged for matching the information from the first document to one of the plurality of medical information items, thereby identifying the medical time period associated with said medical information item as the time period. As such, if the first document describes symptoms of a kidney tumor, the analysis subsystem 140 may match the symptoms to kidney tumor and as such determine the time period as being one month. It is noted that for matching the information from the first document to one of the plurality of medical information items, the analysis subsystem 140 may employ suitable techniques from the field of parsing and in particular the field of human language parsing.

FIG. 4 illustrates the system 100 using the search result to analyze a first document in a document repository and to determine a time period for use in identifying a second document in the document repository. In particular, FIG. 4 provides a schematic display of a plurality of documents 530-536 in the document repository 080 which each have an associated time or date and are displayed along a timeline 400 in accordance with the timestamp. The time or date may be, e.g., a date of creation, a date of last modification, a date of last access, etc. The time or date may also be associated with, or representative of, a particular episode of care of a patient. FIG. 4 further shows the plurality of documents 530-536 being associated with different medical disciplines, e.g., Positron Emission Tomography (PET) imaging 500, Computed Tomography (CT) imaging 510 and lab results 520. The medical discipline may be implicitly or explicitly identified in the document repository 080, e.g., by means of metadata. Similarly, the time or date may be provided by metadata recorded in association with a document, e.g., in the form of a timestamp maintained in the file system of the document repository 080. Alternatively or additionally, the time or date may be provided by the content of a document. The search data may identify a first document 530 as a search result of the query 122. The first document 530 is highlighted in FIG. 4 in black.

In this respect, it is noted that the search data 042 may identify only a single document as the search result of the query. Accordingly, the analysis subsystem 140 may directly proceed with retrieving and analyzing the first document 530. However, the search data 042 may also identify a number of documents in the document repository 080. Accordingly, the analysis subsystem 140 may have to select one of the number of documents for retrieval and analysis. Here, the analysis subsystem 140 may make use of the search data 042 being indicative of a ranking of the number of documents, with the ranking representing a relevance of each respective document in view of the query 122. Accordingly, the analysis subsystem 140 may be arranged for selecting the first document 530 from the number of documents based the ranking, e.g., by selecting a highest ranking document.

Having identified the first document 530, the analysis subsystem 140 may analyze said document to determine a time period based on the first document 530 comprising information which is indicative of the time period. Additionally, the analysis subsystem 140 may make use the query 122 itself to better determine the time period, e.g., by analyzing the first document 530 as well as the query 122. Accordingly, the analysis subsystem 140 may determine a time period 410 which extends both in the past as well as into the future from the date associated with the first document 530. The time period 410 is indicated in FIG. 4 as a double ended arrow 410. It can be seen in FIG. 4 that multiple ones 530-534 of the plurality of documents 530-536 fall within the time period 410.

To identify a second document based on the time period 410, the analysis subsystem 140 may generate filter criteria which may be applied to the documents 530-536 in the document repository 080. FIG. 4 visually illustrates the filter criteria in the form of a dashed bounding box 420. It can be seen that the filter criteria of FIG. 4 are based solely on the time period 410 and, e.g., not on the medical discipline, in that the dashed bounding box 420 encompasses all documents 530-534 which fall within the time period 410.

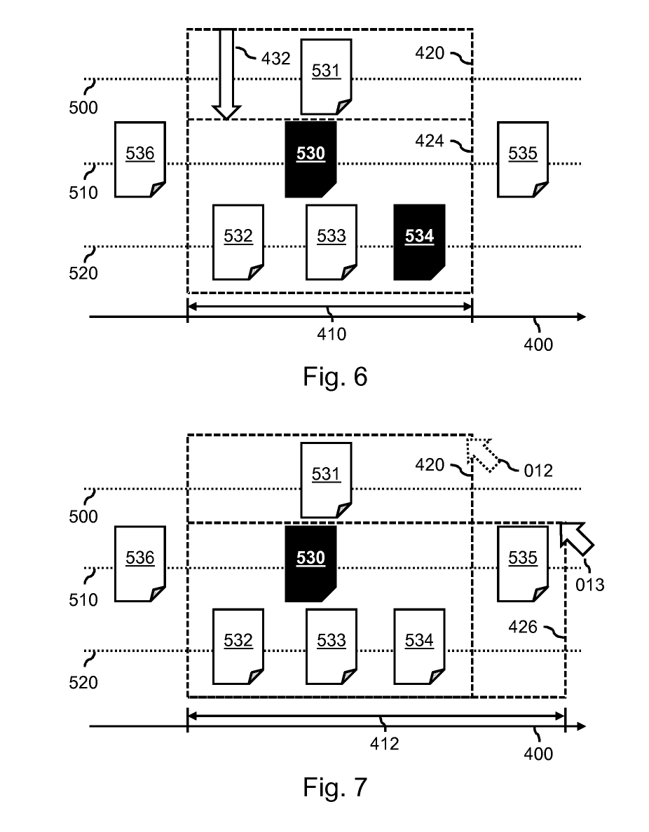

FIG. 5 illustrates the system 100 identifying the second document in the document repository based on the time or date of the second document falling within the time period 410. The second document 534 as identified by the analysis subsystem 140 is, as is the first document 530, highlighted in black. To identify the second document 534 amongst the multiple documents 530-534 falling within the time period 410, the analysis subsystem 140 may apply additional filter criteria to the multiple documents 530-534. For example, as is also illustrated in FIG. 6, the analysis subsystem 140 may restrict its selection of the second document to a particular medical discipline such as the aforementioned CT imaging 510 and/or lab results 520. Alternatively or additionally, if the second document 534 is identified based on the analysis subsystem 140 generating a second query for the search engine 040 which specifies the time period 410, the second document 534 may be identified as a first mentioned or highest ranking one, if the search results identify multiple documents.

The analysis subsystem 140 may be arranged for iteratively updating the time period based on an analysis of a previously identified document such as the second document 534. FIG. 5 shows a result of this, in that an analysis of the content of the second document 534 causes the analysis subsystem 140 to expand the time period further into the future, thereby yielding an updated time period 412. The expansion of the time period is shown in FIG. 5 by means of an arrow 430 indicating the expansion of the dashed bounding box 420 as provided by updated filter criteria. Accordingly, the updated filter criteria may identify a further document 535, which is shown in FIG. 5 by the further document 535 falling within the updated dashed bounding box 422. Although not further shown in FIG. 5, the analysis subsystem 140 may thus iteratively refine the time period and subsequently generate the supplementary data 142 to identify all the documents falling within the refined time period.

FIG. 6 illustrates the system 100 identifying the second document 530 in the document repository further based on a medical discipline 520 associated with the second document. For example, the analysis subsystem 140 may identify the second document 534 only amongst the medical disciplines of CT imaging 510 and lab results 520. The more stringent filter criteria are illustrated in FIG. 6 by means of the dashed bounding box 420 contracting, thereby establishing a contracted dashed bounding box 424 in correspondence with the more stringent filter criteria. It can be seen that a further document 531 is not considered by the analysis subsystem 140 when identifying the second document 534.

FIG. 7 illustrates possible functionality of the system 100 when comprising the user interaction subsystem 160. Here, the schematic display of the plurality of documents 530-536 as shown in FIG. 7 may be shown to the user, e.g., on the display 010. The user interaction subsystem 160 may be arranged for indicating the time period 412 to the user, e.g., in the form of the double ended arrow 412, the dashed bounding box(es) 420, 426, or in another form. The user interaction subsystem 160 may also be arranged for enabling the user to interactively modify the time period 410. For example, FIG. 7 shows the user interactively resizing the dashed bounding box 420 so as to obtain an updated dashed bounding box 426, namely by the user performing a drag-and-drop operation with an onscreen cursor 012, 013 which is operated by the user input device 020. The updated dashed bounding box 426 may indicate to the analysis subsystem 140 to use an updated time period 412, i.e., which extends into the future compared to the time period 410 as determined by the analysis subsystem 140 from the first document 530. In addition, the updated dashed bounding box 426 may indicate to the analysis subsystem 140 to identify the second document 534, or a further document, only from the medical disciplines of CT imaging 510 and lab results 520.

Although not shown in FIG. 7, the user interaction subsystem 160 may be arranged for enabling the user to input a time limit, e.g., by entering the time limit as text or by moving or resizing a graphical representation of the time limit. For example, the user may specify the time limit in relation to a timestamp of the first document 530, e.g., as +/− one month, indicating a time limit running from one month in the past to one month in the future with respect to the timestamp of the first document 530. The analysis subsystem 140 may be arranged for determining the time period 410 based on the time period falling within the time limit. For example, the analysis subsystem 140 may clip the time period 410 to the user-specified time limit. Another option is that if the analysis subsystem 140 determines multiple time periods based on the analysis of the first document 530, the analysis subsystem 140 may select one of said multiple time periods which falls within the user-specified time limit.

The user interaction subsystem 160 may also provide additional functionality. For example, when the user manually updates the time period or selects another document within the time period, the analysis subsystem 140 may automatically analyze the documents falling within the updated time period and subsequently again update the time period. Alternatively or additionally, the user interaction subsystem 160 may provide a snap-action to the time period 410 when the user interactively modifies the filter criteria, i.e., by adjusting the dashed bounding boxes associated therewith or the time period 410 directly.

Although not shown in any of the previous figures, the system may further comprise a reporting subsystem arranged for generating a report based on a content of the first document, and supplementing the report based on a content of the second document. Generating the report may comprise including portions of the content of both documents. The report may constitute a document summary or so-termed snippet view. The report may comprise a summary of the first document which is extended by a summary of the second document and/or further documents, thereby enabling communicating the context of the search result. The report may also contain actionable links to each of the reported documents in the document repository to enable browsing through the documents via the report.

It will be appreciated that the present invention builds upon the following insights. A search result may be meaningful in isolation. Additional information might exist in other or prior documents. Medical documents may relate to each other in time, e.g., due to belonging to a same episode of care, and/or in medical discipline. Different types of pathology and anatomy relate to different relevant time period. The present invention enables the time period to be determined based on the pathology and/or anatomy mentioned in the first document, with each pathology and/or anatomy providing a different time period.

It will be appreciated that the invention also applies to computer programs, particularly computer programs on or in a carrier, adapted to put the invention into practice. The program may be in the form of a source code, an object code, a code intermediate source and an object code such as in a partially compiled form, or in any other form suitable for use in the implementation of the method according to the invention. It will also be appreciated that such a program may have many different architectural designs. For example, a program code implementing the functionality of the method or system according to the invention may be sub-divided into one or more sub-routines. Many different ways of distributing the functionality among these sub-routines will be apparent to the skilled person. The sub-routines may be stored together in one executable file to form a self-contained program. Such an executable file may comprise computer-executable instructions, for example, processor instructions and/or interpreter instructions (e.g. Java interpreter instructions). Alternatively, one or more or all of the sub-routines may be stored in at least one external library file and linked with a main program either statically or dynamically, e.g. at run-time. The main program contains at least one call to at least one of the sub-routines. The sub-routines may also comprise function calls to each other. An embodiment relating to a computer program product comprises computer-executable instructions corresponding to each processing step of at least one of the methods set forth herein. These instructions may be sub-divided into sub-routines and/or stored in one or more files that may be linked statically or dynamically. Another embodiment relating to a computer program product comprises computer-executable instructions corresponding to each means of at least one of the systems and/or products set forth herein. These instructions may be sub-divided into sub-routines and/or stored in one or more files that may be linked statically or dynamically.

The carrier of a computer program may be any entity or device capable of carrying the program. For example, the carrier may include a storage medium, such as a ROM, for example, a CD ROM or a semiconductor ROM, or a magnetic recording medium, for example, a hard disk. Furthermore, the carrier may be a transmissible carrier such as an electric or optical signal, which may be conveyed via electric or optical cable or by radio or other means. When the program is embodied in such a signal, the carrier may be constituted by such a cable or other device or means. Alternatively, the carrier may be an integrated circuit in which the program is embedded, the integrated circuit being adapted to perform, or used in the performance of, the relevant method.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

1. A system for processing a search result of a medical query which is submitted to a search engine, the system comprising:
an interface for receiving search data constituting a response of the search engine to the medical query, the search data identifying a first document in a medical document repository;
an analysis subsystem for:
i) retrieving the first document from the medical document repository;
ii) accessing a medical database comprising a plurality of medical information items, each of the plurality of medical information items being associated with a medical time period;
iii) analyzing the content of the first document to determine a time period based on the first document comprising information which is indicative of the time period and by matching the information from the first document to one of the plurality of medical information items, thereby identifying the medical time period associated with said medical information item as the time period;
iv) identifying a second document in the medical document repository based on a time or date associated with the second document falling within the time period;
v) generating supplementary data identifying the second document in the medical document repository for enabling identifying the second document together with the response of the search engine to the medical query.

2. The system according to claim 1, wherein the plurality of medical information items comprises at least one of: a pathology and an anatomy.

3. The system according to claim 1, wherein the analysis subsystem is arranged for identifying the second document in the medical document repository by generating a second query for the search engine which specifies the time period.

4. The system according to claim 1, wherein the search data identifies a plurality of documents in the medical document repository, wherein the search data is indicative of a ranking of the plurality of documents, and wherein the analysis subsystem is arranged for selecting the first document from the plurality of documents based the ranking.

5. The system according to claim 1, wherein the analysis subsystem is arranged for identifying further documents in the medical document repository by iteratively updating the time period based on an analysis of a previously identified document.

6. The system according to claim 1, further comprising a user interaction subsystem arranged for:
enabling a user to input the medical query for submission to the search engine via the system; and
visually indicating the first document and the second document to the user in response to the query.

7. The system according to claim 6, wherein the user interaction subsystem is arranged for indicating the time period to the user.

8. The system according to claim 7, wherein the user interaction subsystem is arranged for enabling the user to modify the time period, and wherein the analysis subsystem is arranged for identifying the second document or a further document based on said modified time period.

9. The system according to claim 6, wherein the user interaction subsystem is arranged for enabling the user to input a time limit, and wherein the analysis subsystem is arranged for determine the time period based on the time period falling within the time limit.

10. The system according to claim 6, wherein the analysis subsystem is arranged for determining the time period further based on the medical query indicative of the time period.

11. The system according to claim 1, further comprising a reporting subsystem arranged for:
generating a report based on a content of the first document; and
supplementing the report based on a content of the second document.

12. A workstation or imaging apparatus comprising the system according to claim 1.

13. A method for processing a search result of a medical query which is submitted to a search engine, the method comprising:
receiving search data constituting a response of the search engine to the medical query, the search data identifying a first document in a medical document repository;
retrieving the first document from the medical document repository;
accessing a medical database comprising a plurality of medical information items, each of the plurality of medical information items being associated with a medical time period;
analyzing the content of the first document to determine a time period based on the first document comprising information which is indicative of the time period and by matching the information from the first document to one of the plurality of medical information items, thereby identifying the medical time period associated with said medical information item as the time period;
identifying second document in the medical document repository based on a time or date associated with the second document falling within the time period; and
generating supplementary data identifying the second document in the medical document repository for enabling identifying the second document together with the response of the search engine to the medical query.

14. A computer program product comprising instructions for causing a processor system to perform the method according to claim 13.
